(19) United States
(12) Patent Application Publication
(10) Pub. No.: US 2025/0371859 A1
(43) Pub. Date: Dec. 4, 2025

(54) Generative Adversarial Network for Improved Classification of Label-Limited Training Datasets

(71) Applicant: The Board of Trustees of the University of Illinois, Urbana, IL (US)

(72) Inventors: Andrew D B Leakey, Champaign, IL (US); Sebastian Varela, Eucaliptus (UY)

(21) Appl. No.: 19/225,876

(22) Filed: Jun. 2, 2025

Related U.S. Application Data
(60) Provisional application No. 63/655,154, filed on Jun. 3, 2024.

(51) Int. Cl. G06V 10/82; G06N 3/048; G06N 3/09

(52) U.S. Cl. CPC G06V 10/82; G06N 3/048; G06N 3/09

(57) ABSTRACT

Large amounts of high-accuracy annotated data are generally required to train a machine learning model to accurately classify input images. These requirements are significantly increased when the distribution of the images vary significantly with respect to factors like lighting, cultivar strain, or other conditions that are irrelevant to the factor of interest to be classified. Embodiments described herein employ generative adversarial networks to bootstrap a large amount of unlabeled images of a target (e.g., flowering plant) to learn the “classification irrelevant” aspects of the distribution of input images, allowing significantly smaller numbers of accurately labeled images to be used to obtain desired levels of classification accuracy. These embodiments can be used to identify flowering status in images of plants, or to identify other states in other subjects of interest where images thereof may represent significant factors (e.g., lighting, weather) that are not relevant to the classification task.

### CROSS-REFERENCE TO RELATED APPLICATION

This application claims priority to U.S. Provisional Patent Application No. 63/655,154, filed on Jun. 3, 2024, the contents of which are hereby incorporated by reference in their entirety.

### STATEMENT REGARDING FEDERALLY SPONSORED RESEARCH OR DEVELOPMENT

This invention was made with government support under DE-SC0018420 awarded by the Department of Energy, and 2020-67021-32799 awarded by the Department of Agriculture. The government has certain rights in the invention.

### BACKGROUND

Machine learning models can be trained, using training datasets of images, signal waveforms, vectors, or other input data, to predict, from an enumerated set of possible classes, the classes of novel inputs. For example, a training dataset of images of Miscanthus plants or of some other crop that have been manually labeled to indicate whether the crop in each image has flowered can be used to train a machine learning model (e.g., a convolutional neural network) to predict whether novel images of the crop have or have not flowered. In practice, the number of labeled instances of input (e.g., images of a crop labeled as to whether they have flowered) needed to train the model to a desired level of accuracy can be high, especially where the available training data exhibits a great deal of variation that is unrelated to differences between the classes of interest (e.g., where the images differ with respect to lighting conditions, weather or other environmental conditions, or the specific cultivar or other phenotypic aspects of the imaged target).

Obtaining accurately-labeled training data may be time-consuming, expensive, or otherwise difficult. Significantly larger amounts of unlabeled input (e.g., unlabeled images of Miscanthus or another crop of interest) may be available for training, e.g., via transfer learning. However, it is difficult to use such training datasets, having small amounts of labeled data and larger amounts of unlabeled data, especially where the proportion of labeled training data is very small. Additionally, available methods for using such unlabeled training data to train a model may rely on domain-specific knowledge or other particulars of the classification problem, limiting available techniques to specific applications and/or requiring extensive manual fine-tuning.

### SUMMARY

In a first aspect, a computer-implemented method is provided that includes: (i) applying images from a first training dataset to a machine learning model to generate respective predicted classes, wherein the images of the first training dataset depict respective instances of a target; (ii) generating first loss information based on an accuracy of the predicted classes; (iii) operating a generative model to generate a first plurality of images of a second training dataset, wherein the second training dataset also includes a second plurality of images that depict respective instances of the target; (iv) applying images from the second training dataset to the machine learning model to generate respective predictions of whether the images in the second training dataset were generated by the generative model; (v) generating second loss information based on an accuracy of the predictions; and (vi) updating the machine learning model based on the first and second loss information.

In a second aspect, a non-transitory computer readable medium is provided having stored therein instructions executable by a computing device to cause the computing device to perform the method of the first aspect.

In a third aspect, a system is provided that includes: (i) at least one processor; and (ii) a non-transitory computer-readable medium, having stored therein instructions executable by the at least one processor to cause the system to the method of the first aspect.

The features, functions, and advantages that have been discussed can be achieved independently in various examples or may be combined in yet other examples further details of which can be seen with reference to the following description and drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

The accompanying drawings are included to provide a further understanding of the system and methods of the disclosure and are incorporated in and constitute a part of this specification. The drawings illustrate one or more embodiment(s) of the disclosure, and together with the description serve to explain the principles and operation of the disclosure

FIG. 1 depicts aspects of a method for training predictive models, in accordance with example embodiments.

FIG. 2 depicts experimental results.

FIG. 3 depicts experimental results.

FIG. 4 depicts experimental results.

FIG. 5 depicts experimental results.

FIG. 6 depicts experimental results.

FIG. 7 depicts aspects of example machine learning models, in accordance with example embodiments.

FIG. 8 depicts a flowchart of a method, in accordance with example embodiments.

### DETAILED DESCRIPTION

The following detailed description describes various features and functions of the disclosed embodiments with reference to the accompanying figures. The illustrative embodiments described herein are not meant to be limiting. It may be readily understood that certain aspects of the disclosed embodiments can be arranged and combined in a wide variety of different configurations, all of which are contemplated herein.

To that end, example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false

### I. Overview

In some scenarios, a large number of training examples (e.g., images of instances of a crop or other target of interest) may be available to train a machine learning model to classify the images, however, only a small percentage of those training examples may be accurately labeled so as to permit their use in training the model in a supervised fashion. Obtaining accurate labels for unlabeled training examples (e.g., by presenting one or more human graders with the images and receiving labels therefrom) can be costly with respect to time, human effort, and other factors.

Thus, it may be beneficial to leverage the available unlabeled training examples, alone or in combination with the set of labeled training examples, to train a classifier or other machine learning model. This can include transfer learning or other unsupervised or semi-supervised techniques. However, previously available techniques still require large amounts of labeled training data, and perform poorly when the proportion of available training data that is labeled is small and/or where the distribution of the training data varies significantly with respect to conditions unrelated to the properties to be classified (e.g., where the training data includes images of a crop that vary with respect to lighting or other environmental conditions and/or that depict varying cultivars or phenotypes of the crop).

The embodiments described herein allow training datasets having low proportions of labeled examples (e.g., less than 20%, less than 10% labeled examples, less than 1% labeled examples) to be used to train highly accurate classifiers or other machine learning models by leveraging a generative adversarial network to ‘learn’ information about the underlying structure of the inputs, some of which may be unrelated to the properties to be classified (e.g., to lighting or environmental conditions and not to the flowering status of a crop). This extensive knowledge, gleaned via the adversarial training process and present in the ‘discriminator’ portion of the generative adversarial network, can be further trained and used to accurately classify novel inputs using smaller amounts of labeled training data than is possible using prior methods. This performance is possible even in applications wherein the training data (e.g., images of a crop) vary significantly with respect to aspects of the distribution other than those relating to the classification(s) of interest.

These embodiments may, in some examples, allow the amount of labeled image data to be reduced, in some examples obtaining that reduction in training data by an increase in the computational cost to train the model. For example, increasing the number of iterations of training of the discriminator, and the added generator, model in a generative context in order to learn the underlying structure of the image data related both to the target factor(s) to be classified as well as unrelated factors (e.g., lighting, environmental conditions) while allowing less labeled data to be used to train the discriminator in a supervised context in order to obtain a desired level of accuracy with respect to the target classification task.

A machine learning model as described herein may share significant aspects with and/or be the same as the discriminator model of a generative adversarial network. During a portion of the training of this discriminator model, labeled input examples across the two or more possible classes to be predicted (e.g., images of ‘flowering’ and ‘not flowering’ crops labeled as such) are applied to the discriminator. The output of the discriminator model (e.g., an output head of the model specific to the classification task) is then used to update weights or otherwise train the discriminator model, based on the error of the classifications (i.e., based on, for each input example, whether the discriminator correctly classified the input image, e.g., as ‘flowering’ or ‘not flowering’).

During another portion of the training, ‘real’ input examples (e.g., images of crops in varying states of flowering), which may be labeled or unlabeled, are applied to the discriminator along with ‘fake’ input examples generated by a generative model. The output of the discriminator model (e.g., an output head of the model specific to the real/fake input discrimination task) is then used to update weights or otherwise train the discriminator model based on the error of the predictions (i.e., based on, for each input example, whether the discriminator correctly predicted whether the input image was real or generated by the generative model).

Both of the above training steps update shared portions (e.g., a feature extractor) of the discriminator model's architecture. During an additional portion of the training, ‘fake’ images generated by the generator are passed to the discriminator (in this portion of the training, the discriminator weights are not updated). The output of the discriminator model (e.g., an output head of the model specific to the real/fake input discrimination task) is then used to update weights or otherwise train the generator model, based on the error of the predictions (i.e., based on, for each input example, whether the discriminator correctly predicted whether the input image was real or generated by the generative model).

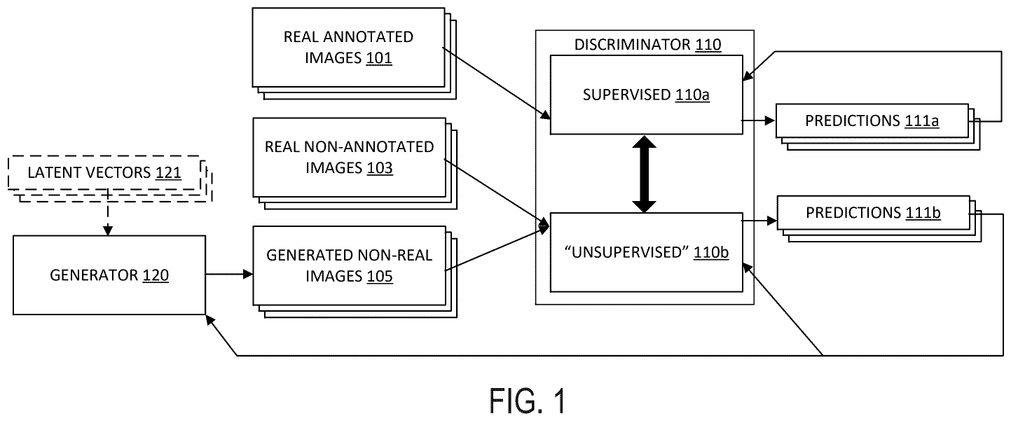

FIG. 1 depicts aspects of an example of such a model training method. A set of training data, representing images of a target (e.g., of a target plant) is obtained, including a labeled training dataset (“REAL ANNOTATED IMAGES”) 101 whose images have classifier labels (e.g., human-generated annotations as to whether the plant depicted therein is flowering or not) and an additional training dataset of unlabeled images (“REAL NON-ANNOTATED IMAGES”) 103 whose images depict instances of the same target across the possible labeled states, but which is not associated with classification labels. A discriminator 110 includes a supervised sub-discriminator 110a and a non-supervised discriminator 110b that share some or all of their trained model parameters (indicated by the bold double-headed arrow). In practice, this can include the two sub-models sharing substantially all of their parameters except for a few parameters related to generating respective outputs (i.e., outputs 111a predicting the class label of an input image or outputs 111b predicting whether the input was real or generated by the generator 120. For example, two parameters each relating to softmax, rectified linear, or other types of output units for each sub-model that receive intermediate outputs from identical upstream units/layers of the discriminator 110. A generator 120, optionally conditioned on an input latent vector 121, can be used to generate a simulated training dataset (“GENERATED NON-REAL IMAGES”) 105.

The simulated images 105 can be used, in combination with the unsupervised sub-model 110b, to generate predictions 111b as to whether a given input image is real; these predictions 111b can then be used to update the generator 120 to generate more realistic simulated images. The simulated images 105 can be used, in combination with the non-labeled real images 103, to generate additional predictions 111b using the unsupervised sub-model 110b; these additional predictions 111b can be used to update the unsupervised sub-model 110b of the discriminator 110 to more accurately distinguish between real and simulated images. This training can assist the discriminator 110 in learning the distribution of real images of the target, thereby facilitating specific learning of the aspects of such images that are most salient to classifying input images with respect to the class(es) of interest. The labeled real images 101 can be used to generate predictions 111a using the supervised sub-model 110a; these predictions 111a can be used to update the supervised sub-model 110a of the discriminator 110 to more accurately classify real images with respect to the target class(es) (e.g., with respect to a plant depicted in an image is flowering or not flowering). The process of generating such various predictions (e.g., predicted classes based on whether an input real labeled image corresponds to which class, predictions of whether an input simulated image is real or simulated, predictions of whether an input, which may be real or simulated, is real or simulated) and updating the corresponding portion(s) of the discriminator 110 and/or generator 120 may be performed in a set sequence, at the same time, or in some other sequence. For example, a first set of updates to the discriminator 110 could be determined based on predictions of whether a set of input labeled images 101 was correctly classified by the supervised sub-model 110a and based on predictions of whether a set of real unlabeled 103 and simulated 105 images was correctly predicted as real or simulated by the unsupervised sub-model 110b. Such a discriminator 110 update phase could alternate with phases to update the generator 120 based on predictions of whether a set of simulated images 105 were incorrectly predicted as real by the unsupervised sub-model 110b.

Once training has been completed, the trained supervised sub-model 110a can then be used to classify novel input images of the target in order to predict which class(es) their contents are in. For example, to predict whether novel images of a grass or other target is or is not flowering.

By training the discriminator model in this multi-step manner, rather than via the end-to-end training previously used for individual convolutional neural networks, the embodiments described herein are able to achieve exceptional error convergence through progressive weight updates between the discriminator and generator components while using significantly fewer (e.g., less than 20%, less than 20%, less than 1%) labeled training examples than alternative methods. Conversely, the embodiments described herein may obtain such improvements as a tradeoff with increased computational cost of the training (e.g., more rounds of update of the discriminator model, added rounds of updating the generator model).

Note that several of the specific embodiments described herein describe the use of these embodiments to predict the flowering/non-flowered status of various grasses or other plants. These are intended as non-limiting example embodiments only. These embodiments can be applied to a variety of image classification tasks (e.g., detection of flowering, ripeness, or other growth or fruiting status of other plants, detection hydration status or other classifications of plants, or detection of some other class or state of plants, animals, objects, vehicles, items, or other targets on interest) in order to obtain a desired level of classification accuracy using a reduced number of labeled training examples (e.g., less than 20%, less than 10%, or less than 1%) relative to alternative methods, even in the face of significant non-classification-relevant variation in the training images (e.g., relating to lighting, environmental conditions, or other confounding variation).

It should be understood that arrangements described herein are for purposes of example only. As such, those skilled in the art will appreciate that other arrangements and other elements (e.g. machines, interfaces, operations, orders, and groupings of operations, etc.) can be used instead of or in addition to the illustrated elements or arrangements

### II. Example Embodiments and Experimental Results

The embodiments described herein were developed into a number of example implementations, which are described in greater detail in this section. Some of these example implementations were experimentally evaluated, and the results of such experimentation is also provided in this section

Machine learning (ML) can accelerate biological research. However, the adoption of such tools to facilitate phenotyping based on sensor data has been limited by (i) the need for a large amount of human-annotated training data for each context in which the tool is used and (ii) phenotypes varying across contexts defined in terms of genetics and environment. This is a major bottleneck because acquiring training data is generally costly and time-consuming. The embodiments herein address these challenges by reducing the amount of labeled training examples needed for tool building. An experimental validation was performed to compare ML approaches that examine images collected by an uncrewed aerial vehicle to determine the presence/absence of panicles (i.e. “heading”) across thousands of field plots containing genetically diverse breeding populations of 2 Miscanthus species. Automated analysis of aerial imagery enabled the identification of heading approximately 9 times faster than in-field visual inspection by humans. Leveraging an Efficiently Supervised Generative Adversarial Network (ESGAN) learning strategy as described herein reduced the requirement for labeled training data examples by 1 to 2 orders of magnitude compared to traditional, fully supervised learning approaches. The ESGAN model learned the salient features of the data set by using thousands of unlabeled images to inform the discriminative ability of a classifier so that it required reduced amounts of labeled training data. The embodiments herein can accelerate the phenotyping of heading date as a measure of flowering time in Miscanthus across diverse contexts (e.g. in multistate trials).

Some of the embodiments herein include the use of a generative adversarial learning strategy as an alternative to traditional supervised learning and transfer learning (TL), aiming to reduce the amount of labeled training data needed for supervised training of a computer vision tool. This can include exploiting the ability of a generative adversarial network (GAN) to learn the salient features of data from large amounts of unlabeled images captured with an aerial platform or other image source. Accordingly, the model can learn the underlying latent space within the image data, which can be leveraged to enhance the model's discriminative ability in a classification task with reduced amounts of labeled training data (e.g., relative to training such a discriminator from scratch, without training in the generative context). These embodiments can include using a ‘coinformative’ learning strategy between the unsupervised (discriminating between real and generated images) and supervised (discriminating between different classes of labeled real images) classifiers within the GAN. This allows learning of the salient features of the large, unlabeled image dataset to be complemented by the use of a smaller pool of labeled images to efficiently achieve the classification task at a desired level of accuracy. This approach may be referred to herein as an Efficiently Supervised GAN (ESGAN).

A case study of this approach was performed by classifying thousands of diverse, field-grown Miscanthus genotypes as having produced panicles, or not, on a given date in a time course of imagery collected by an uncrewed aerial vehicle (UAV, or uncrewed aerial system, or drone). Biomass and valuable chemical compounds from dedicated bioenergy crops are expected to play a central role in the provision of more sustainable energy and bioproducts. Miscanthus sacchariflorus and Miscanthus sinensis are crossed to produce very productive, sterile hybrids. Flowering time is a key trait influencing productivity and adaptation of Miscanthus to different growing regions. Flowering time in Miscanthus, like many other grass crops, can be assessed in terms of “heading date,” i.e. when panicles are outwardly visible in 50% of the culms that reach the top of the canopy. Repetitive visual inspections of thousands of individuals grown in extensive field trials are very labor intensive. Repeated assessment of a crop trial to assess when in a seasonal time course, a panicle is first observed then allows estimation of heading date. Increasing the frequency with which the crop is assessed increases the precision of heading date estimates and also increases labor and has motivated the development of ML-enabled remote sensing tools to identify reproductive organs and to assess if plants have reached developmental milestones. However, the challenges of context dependency result in the need for substantial training data, and also limit the generalization ability of such tools as previously implemented.

The embodiments described herein were evaluated to test the ability of ESGAN to classify aerial images of individual plants of M. sacchariflorus and M. sinensis on the basis of panicles being visible or not, i.e. the most repeated and labor-demanding step in heading date determination. The performance of ESGAN was compared to various previous algorithms based on the fully supervised learning (FSL) paradigm and traditional TL with varying degrees of complexity, including K-nearest neighbor (KNN), random forest (RF), custom CNN, and ResNet-50. This analysis was repeated as the number of annotated images provided to train a given model was reduced from 3,137 (100%) to 32 (1%), while simultaneously providing ESGAN with access to the complete set of unannotated images (i.e. n=3,137). The objective was to evaluate the trade-offs between predictive ability and the level of dependence on manual annotation for each of the algorithms. In addition, ESGAN was evaluated with respect to its unique generative and adversarial learning strategy. Finally, class activation visualization was used to evaluate how ESGAN exploits the information in the images to increase its predictive ability

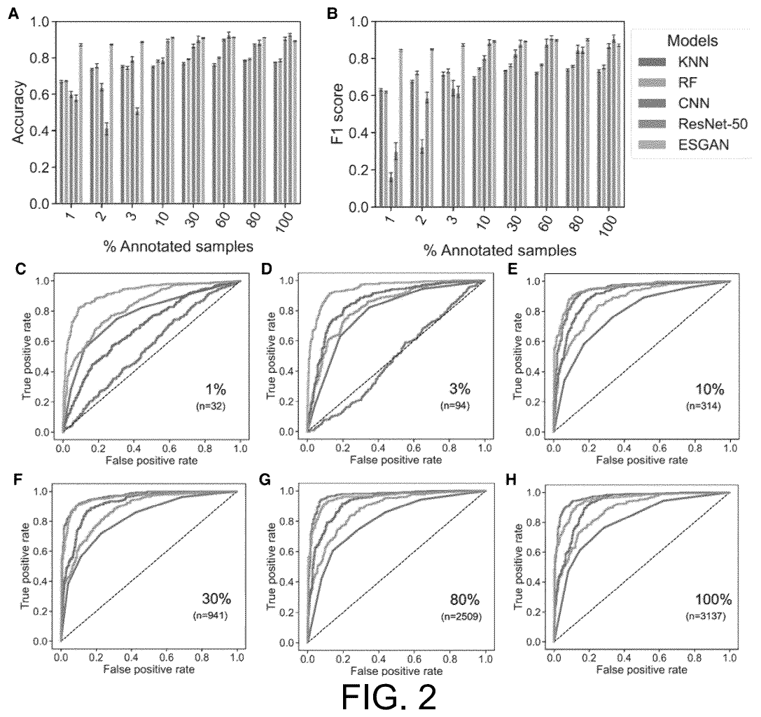

As a baseline, all 5 model types were able to correctly classify whether plants had reached heading or not when provided with the full (100%) training data set of 3,137 images (FIG. 2, panes A, B, and H). The convolutional models CNN, ResNet-50, and ESGAN all performed well (overall accuracy [OA]=0.89 to 0.92, F1 score=0.87 to 0.90) and had superior performance than the tabular methods of KNN and RF (OA=0.78 to 0.79, F1 score=0.73 to 0.76).

All model types demonstrated some reduction in ability to detect heading accurately as the amount of annotated training data was reduced, but to very different degrees. For ESGAN, the penalty for reducing the number of annotated images used for training down to 1% of available data (32 images) was negligible in terms of OA (decline from 0.89 to 0.87), F1 score (decline from 0.87 to 0.85), and receiver operating characteristic (ROC) analysis (FIG. 2). TL using ResNet-50 was the next most robust method, maintaining performance as annotated training data were reduced to 10% (314 images), before being heavily penalized as the amount of annotated training data declined further (FIG. 2). CNN performed at an intermediate level, maintaining performance as annotated training data were reduced to 30% (941 images), before being heavily penalized as the amount of annotated training data decline further (FIG. 2). KNN and RF were less sensitive than CNN and ResNet-50 to reductions in the amount of annotated training data provided, but this only partially compensated for the poorer baseline performance of KNN and RF (FIG. 2).

When the amount of annotated data was most restricted (1% of data available for training), ESGAN's performance (OA=0.87 to 0.89, F1 score=0.85 to 0.87) was substantially better than all other models (OA=0.43 to 0.75, F1 score=0.16 to 0.72) (FIG. 2, panes A and B). This also agreed with the ROC analysis, where ESGAN was the most effective model for correctly identifying the 2 image classes when fewer than hundreds of annotated images were available for training (FIG. 2, panes C and D).

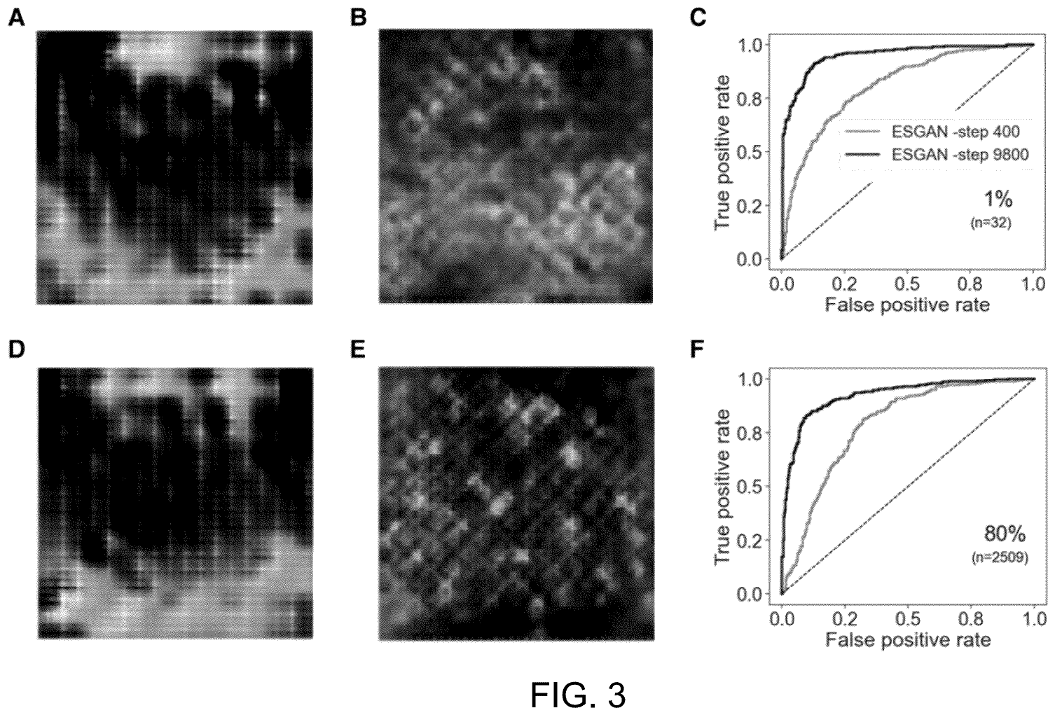

The ability of ESGAN to accurately determine heading of plants from aerial imagery could be related to the synergic contributions of ESGAN's generator and discriminator submodels. The ability of the ESGAN generator to improve the visual representations of “fake” images was notable during the training process (FIG. 3, panes A, B, D, and E). The initial attempts of the ESGAN generator to generate images produced very noisy and unrealistic representations of Miscanthus plants (FIG. 3, panes A and D). The ESGAN generator submodel progressively learned to better match the RGB color intensity and spatial distribution of pixels of the real images, turning them into very realistic representations of plants (FIG. 3, panes B and E). This improvement corresponded with the increasing performance of the ESGAN discriminator (FIG. 3, panes C and F) along the successive minibatch steps of training, where the ability of this submodel to identify plants with panicles consistently improved regardless of whether very few (e.g. 32 images, FIG. 3 pane C) or many (FIG. 3 pane F) annotated training images were provided

FIG. 2 depicts results relating to the evaluation of heading detection in testing data. Performance of benchmarks and ESGAN algorithms are depicted under an increasing number of annotated samples via OA (pane A) and F1 score (pane B) metrics. Error bars represent the SD of performance metrics after 3 training and testing iterations. Performance evaluation using ROC analysis is also presented for the same models under the same conditions in panes C to H. These metrics are explained in greater detail below.

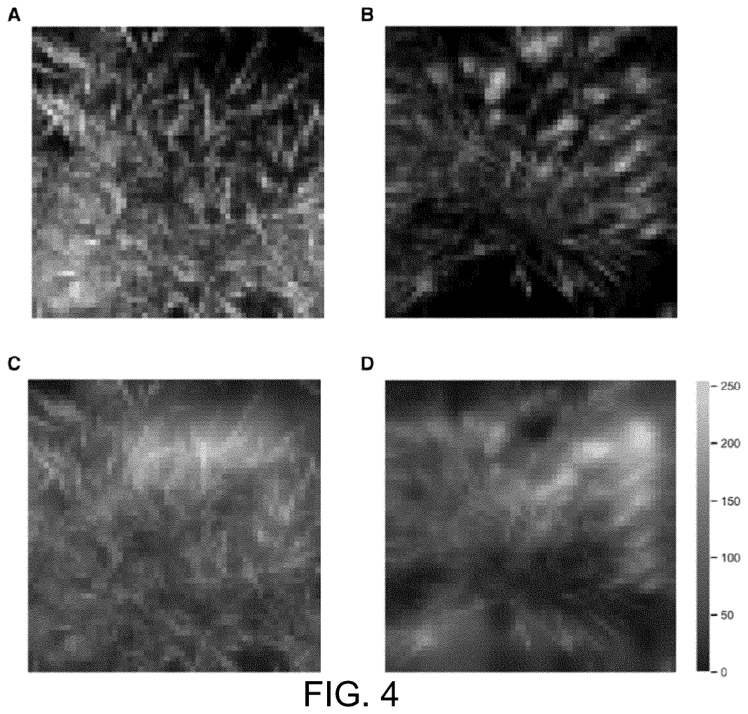

The learning process of the ESGAN model was evaluated via Gradient-weighted Class Activation Mapping (Grad-CAM) to highlight which parts of an image contributed the most to the model's decision. This revealed that the model successfully focused on plant pixels versus background pixels and varied its activation levels depending on the class of image being considered. For plants without visible panicles (FIG. 4, pane A), higher activation regions (yellow) were visibly located over the green areas of the plant, this was especially notable over the upper leaves, while lower leaves and background regions (i.e. soil) were assigned with lower (blue) activation levels (FIG. 4, pane C), meaning they were less informative. For the class of plant that had reached heading (FIG. 4 pane B), higher activation was particularly noticeable over the regions of panicles (i.e. silver-white objects) of the plants, while the model assigned lower activation levels to vegetative tissues (FIG. 4, pane D).

The combined Miscanthus breeding trials depicted herein featured 3,040 plots, including 12,400 individual plants at the time of establishment (1 per plot for M. sacchariflorus and 10 per plot for M sinensis). Heading status of each plant was assessed on 3 occasions. Visual inspection by humans walking through the trials, including recording of data on an electronic device, required approximately 10.5 person-seconds per plant or 36 person-hours in total on each occasion that phenotyping was performed (Table 1). By comparison, the time demand could be reduced>8-fold to 4.33 person-hours in total, or ˜1.2 s per plant, when acquiring images by UAV and analyzing them with ESGAN (Table 1). This reduction in time commitment reduces labor requirements below the threshold where, weather permitting, a single person could maximize the accuracy of heading data estimates by performing phenotyping on a daily basis.

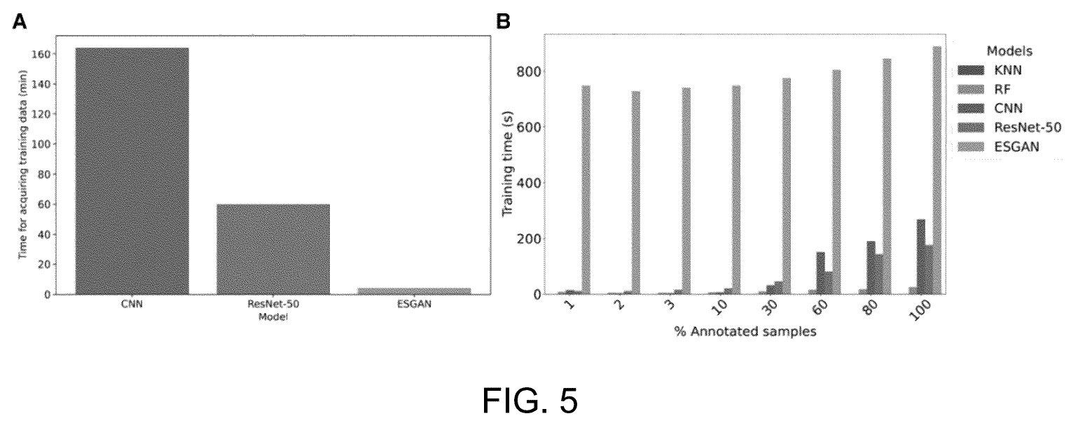

Before ESGAN can be deployed to analyze UAV imagery (or to perform some other discrimination task), it must be trained on labeled (e.g., human-annotated) images. The number of labeled training images (e.g., annotated by in-field, human phenotyping) needed to maximize how accurately plants were classified as having reached heading or not was substantially fewer for ESGAN (˜32 images) than for TL by ResNet-50 (˜314) or a traditional, fully supervised CNN (˜941 images). Based on the average time to phenotype each plant, this means that the time required to collect sufficient annotation data in each new context that an ESGAN or similar model as described herein would be used decreases by an order of magnitude for ESGAN relative to TL and CNN (FIG. 5 pane A).

In addition, the training time for ESGAN varied from ˜750 to 900 s depending on the number of annotated samples analyzed. This was 3- to 4-fold slower than for other learning methods (FIG. 5 pane B). However, this increase in computational time is small compared to the gains in efficiency with respect to the number of labeled training examples that are needed (and corresponding fieldwork or other efforts to generate that label data) (FIG. 5 pane A).

FIG. 3 depicts visual representations of “fake” images generated by the ESGAN generator during modeling implementation at early (400) (panes A, D) and advanced (9,800) (panes B, E) training steps. Evaluation of heading detection by the ESGAN discriminator-supervised classifier at early (400) and advanced (9,800) training steps under limited (1%) (pane C) and large (80%) (pane F) numbers of annotated samples.

FIG. 4 depicts visualizations of examples of real RGB images and Grad-CAM activation maps. Examples of preheading (pane A) plant class and the corresponding activation map (pane C) extracted from ESGAN D supervised classifier. Example postheading (pane B) plant class and the corresponding activation map (pane D). Activation levels in the images are represented on a 0 to 255 scale.

TABLE 1
Description of activities and time required to phenotype
the heading status of Miscanthus breeding trials
by traditional visual inspection on the ground versus
UAV imaging plus analysis by ESGAN
Visual inspection by humans on UAV imaging
and ESGAN analysis the ground

| Activity | Time | Activity | Time |
|---|---|---|---|
| In-field evaluation | 36 h | Flight planning and execution | 1 h 20 min |
| and data recording | | Image processing | 2 h 40 min |
| on an electronic | | Image chip generation and | 20 min |
| device. | | ESGAN predictive inference | |
| | Total 36 h | | Total 4 h 20 min |

Data correspond to the effort required to phenotype the 3 trials (3,040 plots) in this study on 1 occasion, i.e. at a single point in a seasonal time course.

These results successfully demonstrate that an ESGAN or other approach as described herein can substantially reduce the amount of labeled (e.g., human-annotated) training data needed to accurately perform an image classification task. Only tens of labeled human-annotated images were needed to achieve high levels of accuracy in detecting plants that had reaching heading, or not, even when the problem was presented in the challenging context of a large population of Miscanthus genotypes, which feature a wide diversity of visual appearance both before and after heading. By contrast, hundreds of human-annotated images were needed to train a TL tool (ResNet-50), and thousands of annotated images were needed to train a fully supervised CNN. Meanwhile, KNN and RF were not able to classify images with high levels of accuracy, even when provided with thousands of training images. These findings highlight how a generative and adversarial learning strategy as described herein can provide an efficient solution to the common problem of needing large amounts of annotated training data for high-performing FSL DL approaches. This is a particularly significant discovery for the many potential applications of computer vision, such as high-throughput phenotyping in crop breeding, where frequent retraining of a DL model is needed to address the strong context dependency of outcomes. The time required to acquire imagery by UAV and perform analysis with the ESGAN tool was ˜8-fold less than the time required for people to visually assess and record the heading status of Miscanthus while walking through the field trials. The time required to train any of the ML models is trivial relative to the time required for data acquisition. Combined with reducing the requirement for training data by 1 to 2 orders of magnitude by using ESGAN versus FSL or TL, this represents a major reduction in the effort needed to develop and use custom-trained ML models for phenotyping heading date in trials involving other locations, breeding populations, or species. For the Miscanthus breeding program at UIUC, the reduction in labor on each occasion the heading status of the breeding trials is assessed, from 36 to 4.33 person-hours, creates the opportunity to increase the frequency of assessment from once per week to once every 2 or 3 d, and thereby increase the accuracy of heading date estimates.

FIG. 5 depicts the (pane A) time for acquiring annotation data for training for models that accurately classify images (OA>0.85) and (pane B) training time for each model relative to the number of annotated samples in the training data.

The power of the methods described herein (e.g., as implemented in ESGAN) is valuable to research in the biological science domain, particularly at the intersection of remote sensing, precision agriculture, and plant breeding. The integration of automated data collection based on noncontact sensors and ESGAN can provide a cost-effective solution for exploiting large volumes of unannotated inputs, which can be collected at relatively low cost using remote sensing platforms. It can reduce dependence on large annotation data sets while achieving performance equivalent to traditional FSL approaches. Making these advances in a highly productive perennial grass, such as Miscanthus, is particularly important and challenging because these crops are more difficult to phenotype, i.e. highly segregating outbred populations with each individual genetically unique, and voluminous perennial plants that grow larger each year make field screening by humans on the ground more difficult and time-consuming than in annual, short-stature crops. Implementing this ESGAN-enabled strategy may allow breeders to grow and evaluate larger populations in more locations as a means to accelerate crop improvement but at lower cost given the reduced dependence on manual annotation. ESGAN could be applied to assess heading in other important crops including maize (Zea mays), sorghum (Sorghum bicolor), rice (Oryza sativa), wheat (Triticum aestivum), and switchgrass (Panicum virgatum), which also have panicles visible at the top of the canopy. The focus would shift to supplying a reduced number of high quality and strategic annotations, while relying on the generative and adversarial element of the ESGAN to reduce the gap in predictive ability instead of depending on large data collection campaigns required for robust FSL implementations.

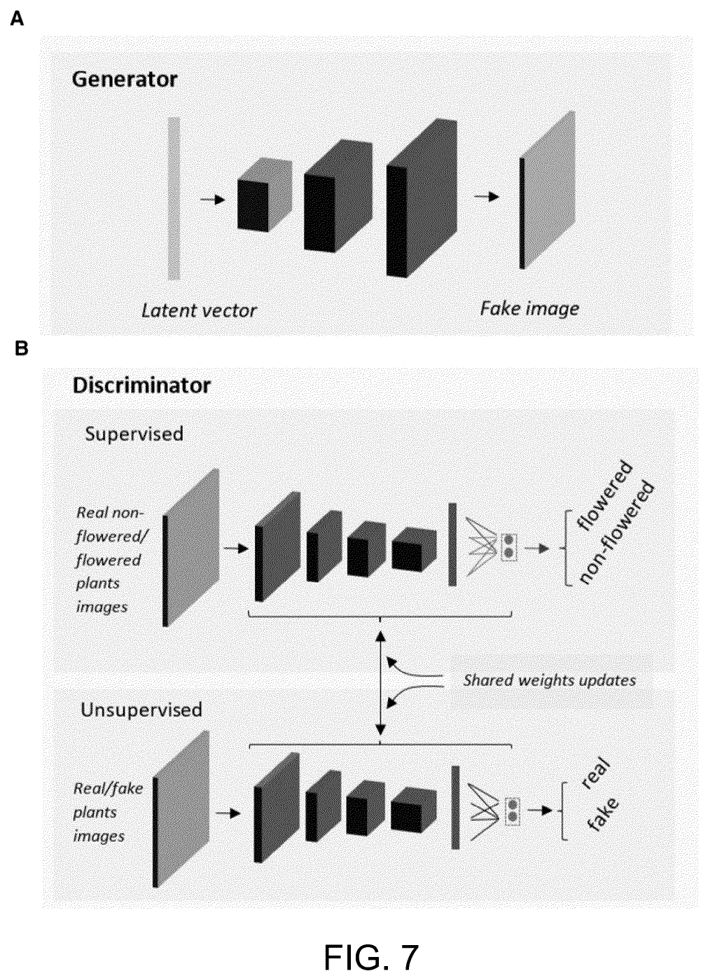

ESGAN clearly outperformed FSL models when only tens of training images were provided. Overall, this highlights the particular ability of ESGAN, as an example of the embodiments described herein, to exploit unannotated imagery to produce meaningful improvements for more accurate determination of the heading status under minimal annotation. This can be attributed to ESGAN's ability to effectively enrich the latent space representation, which is beneficial for classifiers in the discriminator to accurately distinguish between target classes and outperform other convolutional-based benchmark models. ESGAN benefits from using 2 CNNs (one supervised and one nonsupervised classifier) that share weights, allowing synergic feature matching even when annotations are severely restricted. Specifically, the architecture design and training sequence of ESGAN allow weight updates in 1 classifier affect the other one (FIG. 7 pane B), facilitating feature matching. This design and sequence of steps during training allow the model to synergistically exploit both types of data sources (i.e., annotated and unannotated), providing a clear advantage over the FSL and traditional TL strategies. The generative component of the algorithm showed a significant improvement in the quality of the visual representation of Miscanthus plants during the learning process (FIG. 3, panes A, B, D, and E). This allowed synergistic gains in the performance of the ESGAN discriminator and ESGAN generator as gradient updates and loss function information passed between submodels.

The dependence of the CNN model on voluminous amounts of annotated images was strong. This constraint was also evident, although to a lesser degree, when using the TL strategy. This demonstrated that the TL strategy was capable of exploiting prior knowledge, but the dependence on annotated images was consistently larger than for ESGAN.

Grad-CAM showed that the algorithm prioritized information gain from areas of the image occupied by inflorescences and vegetative tissue as a means to differentiate each class without the need for manual supervision to identify regions of interest. This extends the degree to which expert supervision was not needed during implementation of the analysis. This is particularly important in biological systems, such as crop breeding, where high levels of phenotypic diversity from genetic and environmental sources occur, which would otherwise limit the broad application of existing AI tools.

By reducing the dependence on labeled training data (e.g., from manual annotation), the traditional requirement for exhaustive field-wide surveying can be alleviated also to determine the heading dynamics. Rather than conducting comprehensive surveys of the entire field at each round of evaluations, surveying could focus on representative sections to optimize the operational cost. Complementing these targeted ground surveys with aerial surveys would further enhance temporal coverage by better distributing the operational cost associated, without compromising accuracy in heading status predictions and reducing the cost of capturing finer temporal dynamics. ESGAN's strong predictive performance even with reduced data availability suggests that this hybrid approach could maintain high levels of accuracy across time points, offering a practical, cost-efficient, and scalable alternative for large-scale phenotyping in agricultural research.

The generative-discriminative nature of the ESGAN approach described herein, which is characterized by an adversarial and synergic training of neural networks, presents a promising avenue for reducing the dependence on labeled training data (e.g., as a result of human supervision) and enhancing the model's capacity for generalization through more efficient incorporation of contextual information. In the study presented herein, this meant that heading detection in plants could be effectively determined using high-spatial-resolution aerial imagery with only very limited (tens) of human-annotated training images. This represents a significant potential reduction of manual annotation given by ESGAN compared to traditional FSL, all with negligible penalization. These outcomes are valuable for designing future strategies to optimize the integration of manual field screening efforts and aerial data collection. More broadly, this work could address the need for advanced modeling techniques that can produce both robust accuracy while reducing the operational cost of collecting time-consuming annotated data for many computer vision problems in plant science applications

Data were collected from 3 Miscanthus diversity trials located at the University of Illinois Energy Farm, Urbana (40.06722°N, 88.19583°W). The trials were planted in the spring of 2019. This study focused on the second year (2020) of their establishment, which is the first growing season in which the Miscanthus trials are typically phenotyped. The broader aims of the breeding program include assessment of overwintering survival and evaluation of germplasm adapted to a wide range of latitudes and environments. Since plants that were lost to lethal winter temperatures were randomly distributed within the trials, all locations were phenotyped by humans and UAV imaging regardless of survival status. Not all germplasm experienced the photoperiod necessary to achieve a vegetative-reproductive transition and achieve heading at this location.

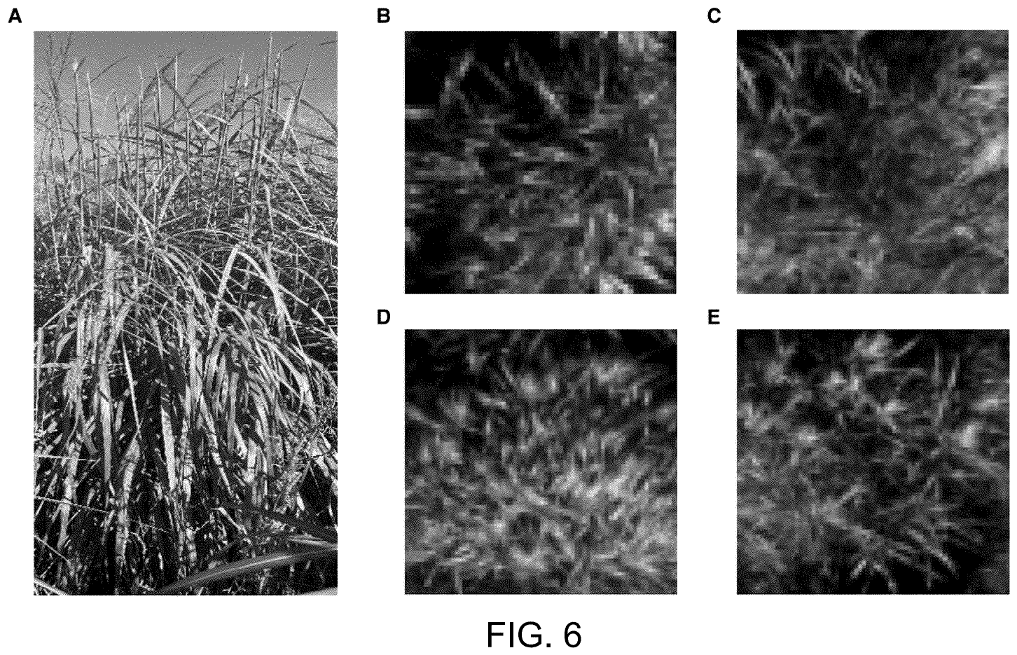

FIG. 6 depicts examples of plants with emerging inflorescences from ground (pane A), plants not yet heading (panes B, C), and plants after heading (panes D, E) from UAV.

The M. sacchariflorus trial included 2,000 entries as single-plant plots in 4 blocks, each block including 58 genetic backgrounds (half-sib families). The size of the trial was 79 m longx97 m wide, and each plot (plant) was 1.83×1.83 m size.

One M. sinensis trial included germplasm from South Japan while the other included germplasm from Central Japan. Each of these 2 trials included 2 blocks, with 130 plots per block. Each plot contained seedlings from a single half-sib family, with 10 plants at a spacing of 0.91 m, requiring transplant of 10,400 individuals in total at the start of the trial. In the M. sinensis South Japan trial, there were 124 families, and in the Central Japan trial, there were 117 families. Therefore, a few families were planted in more than 1 plot per block to avoid leaving empty space. The size of the field that included both of the M. sinensis trials was 115 m long×121 m wide.

Every plant in both single-plant and multi-plant plots was phenotyped individually through observation on the ground by an expert evaluator to determine if it had produced panicles or not. A plant was considered to have reached heading once the culms that contribute to the canopy height have 50% panicles that had emerged>1 cm beyond the flag leaf sheath. Data were recorded to separately track plants that died or never reached heading. Examples of plants with emerging panicles imaged at the ground level and by UAV are shown in FIG. 6. The M. sacchariflorus trial was inspected on day of the year (DOYs) 248, 262, and 276 and the M. sinensis on DOYs 245, 265, and 280. This matched as close as possible (i.e. depending on optimal weather conditions) the dates of UAV data collection imagery collected in the 2020 season.

A Matrice 600 Pro hexacopter (DJI, Shenzhen, China) UAV equipped with a Gremsy T1 gimbal (Gremsy, Ho Chi Minh, Vietnam) mounted with a multispectral RedEdge-M sensor (MicaSense, Seattle, WA, USA) was utilized for aerial data collection. The sensor included 5 spectral bands in the blue (465 to 485 nm), green (550 to 570 nm), red (663 to 673 nm), red edge (712 to 722 nm), and near-infrared (820 to 860 nm) regions of the electromagnetic spectrum. Flights were conducted 3 times (DOYs 247, 262, and 279) in the season corresponding to the period when most inflorescences emerge. The aerial data were collected under clear sky conditions around +1 h from solar noon to ensure consistent reflectance values across days of data collection. The flight altitude was 20 m above ground level, resulting in a ground sampling distance of 0.8 cm/pixel. Flight settings included 90% forward and 80% side overlapping during data acquisition to ensure high-quality image stitching during postprocessing steps. Ten black and white square panels (70 cm×70 cm) were distributed in the trials as ground control points (GCPs). A real-time kinematic survey was done using a Trimble R8 global navigation satellite system integrated with CORS-ILUC local station to survey the GCPs to ensure consistent spatial extraction of the image chips between days of data collection. A MicaSense calibration panel was imaged on the ground before and after each of the flights for spectral calibration of the images via an empirical procedure. Images were imported into Metashape version 1.7.4 (Agisoft, St. Petersburg, Russia) to generate calibrated surface reflectance multispectral orthophotos. Image processing and analysis were performed with a i9-12900H processor, with 14 cores 32 GB RAM, and a NVIDIA Geforce RTX 3080 16 GB GPU. The orthophotos from each of the 3 sampling dates were resampled to a common 0.8-cm/pixel resolution and stacked into a 3-band RGB (i.e. red, green, blue bands) raster stack object. Further steps in the analysis considered only the RGB bands of the multispectral sensor for the following reasons: (i) RGB has proven to be highly sensitive and competitive with the red edge and near-infrared spectral regions of the electromagnetic spectrum for monitoring heading in Miscanthus; (ii) The use of RGB bands allowed testing of TL as potential alternative approach into the analysis. Image chips for each plot/plant were generated by clipping the stacked orthophoto objects using a polygonal shapefile that includes each plot polygon of the trials. The resulting image chips containing the 3 dates of RGB bands were further split into single date matrix arrays in Python for further analysis. The size of the image chips was 108 pixels×108 pixels×3 RGB bands per date.

After accounting for plants that died due to lethal winter temperatures or never reached heading, a subset of 1,309 genetically diverse plants were identified for which ground truth data and UAV imagery were available on each of the 3 sampling dates during the growing season. This resulted in a data set of 3,921 instances of single-plant images and associated heading status.

### KNN and RF

KNN is an extensively used algorithm for pattern classification. The proximity distance between individuals is used to determine class discrimination in a population. The core concept is that the closer the individuals are in the feature space, the higher probability of belonging to the same class. The advantage of this method is the reduced number of parameters and fast computation, while the downside is the sensitivity to irrelevant features and difficulty for determining the optimal value of the parameter number of neighbors. In this study, after preliminary experimentation, parameter number of neighbors was set equal to 10.

RF is a versatile nonparametric algorithm that has been broadly used in classification tasks. It exploits bagging and feature randomness to build an ensemble of trees in which prediction by committee tends to be more accurate than in any of the individual trees. RF is straightforward to use and requires simple hyperparameter tuning to deliver high predictive performance. Another advantage of this algorithm is that it does not assume normal distribution of data or any form of association between the predictors and the response variable. Furthermore, as an ensemble of trees, RF is highly capable for managing overfitting. For implementation, parameters number of estimators and maximum depth of trees were optimized via GridSearchCV function in Python.

The KNN and RF algorithms require tabular features as inputs for modeling implementation. Tabular-based features were generated from the image chips using Numpy Stats functions in Python. Statistical descriptors median, range, SD, percentile 75, percentile 95, and percentile 99 values were utilized to extract tabular feature values from the RGB bands of each of the image chips (based on structural and multispectral bands not contributing additional explanatory power in prior assessment of heading by Miscanthus in UAV images). This process generated a total number of 18 features that were further used as inputs of the algorithms to determine the heading status of each of the plants (i.e. image chip level).

### Custom CNN

CNN is a deep learning technique successfully utilized for image analysis. The architecture of the algorithm consists of a series of hidden layers that map the input images to output values. The core component of the algorithm is the convolution operation, where a set of trainable kernels are applied to the input image to automatically generate a set of spatial features that best describe the target predictor. The model learns basic features in the first layers and more complex feature representations at deeper layers iteratively (i.e. via gradient loss and backpropagation). The typical architecture of the algorithm includes a backbone feature generator and classifier or regressor head. In this study, the backbone feature extractor of the custom CNN includes 6 convolutional layers all including maximum pooling and batch normalization. Convolutional Layers 2, 4, and 6 additionally consider 40% features dropout, flattening layer. Then, the backbone feature extractor also included a fully connected layer, batch normalization, and 50% feature dropout. Finally, the classifier head of the CNN includes a sigmoid activation layer that delivers predictions as normalized probability distribution values (i.e. with panicles or without panicles) for each image chip. After preliminary experimentation, the number of features in each layer was set to 32, 32, 64, 64, 128, and 128. Zero padding, stride equal to 1 with no overlapping, and rectified linear unit (ReLU) activation function were also considered in the architecture design. The CNN's kernel filter size was set to 3 pixels×3 pixels×3 RGB bands, and max pooling was set equal to 2 following each convolution. Binary cross entropy was utilized as loss function of the classifier head of the neural network

### ResNet-50

TL is a deep learning technique that exploits stored knowledge gained while solving one problem that can be then applied to solve a different but related task. This prior knowledge is stored in large neural networks and then transferred to solve a target task. This implies several advantages over training a custom CNN from scratch, e.g. reduction in computational resources and latency for delivering predictions, and boost in predictive ability over the target task. Deep neural networks trained on ImageNet data set have reported state-of-the-art performance in TL applications. ResNet-50 is a deep 50-layer neural network specifically designed to exploit residual connections between convolutional layers trained on large ImageNet data set. This ensures that weights learned from previous layers do not vanish during backpropagation, which represents an advantageous trick in the design that enables the use of a large number (i.e. deeper) of layers in the architecture of the network. For implementation, a strategy as follows was employed: (i) remove the original head of the pretrained neural network, (ii) add a custom binary classifier head, and (iii) fine-tune the top 5 layers while keeping bottom layers frozen. ResNet-50's pretrained weights and biases were imported from Keras. The original image chips were resampled to a 128-pixel size to fit the input image size of the ResNet-50 network

### ESGAN

GAN involves training deep generative networks based on game theory. The model contains 2 CNN submodels: (i) a generator (G) and (ii) a discriminator (D) that are trained in an adversarial manner. Both G and D are trained to optimize the overall results, where the goal of G is to mislead D, and the goal of D is to distinguish between fake images generated by G and real images collected with the UAV. GAN has been successfully implemented for image generation, augmentation, and classification tasks. During the training process, the data generated by the generator (G) was used to train the discriminator (D). This process enabled D not only to distinguish between real and fake data but also to identify whether a plant has reached the heading stage (FIG. 1). Therefore, D can learn features that allow for the discrimination of images with plants prior to, or after, heading using much less labeled (e.g., human-annotated) training data than in FSL.

ESGAN was implemented by creating separated classifiers for supervised and unsupervised D (FIG. 7). First, the D supervised classifier was implemented to infer the 2 classes (i.e. plants prior to heading or after heading) from real images using Softmax activation function. Then, the supervised D produced predictive outputs for each image (i.e. between 0 and 1), which represent the normalized probability of the image belonging to the 2 image classes. The D unsupervised classifier was implemented by taking D supervised prior to the Softmax activation (i.e. the D supervised backbone feature extractor) and reusing its feature extraction layers weights. It then calculates the normalized sum of exponential outputs (i.e. between 0 and 1) via a custom function, which represents the probability of the image being real or fake. This means that updates to one of the classifier models will impact both models.

The supervised loss function (L_{D supervised}) was defined as the negative log probability of y when the correct class is allocated by x. L_{D supervised} focuses on correctly classifying input images to given labels.

L_{Dsupervised}=E_{x,y˜Pdata(x,y)}log_{Pmodel}(y|x,y<K+1) (1)

Unlabeled image loss functions constitute the unsupervised loss function (L_{Dunsupervised}). P_{model} (y=K+1|x) represents the probability that x is fake, corresponding to the 1-D (x) of GAN architecture. Xᵤ denotes unannotated data samples. The unannotated real images were classified to one of the K classes by the first term of L_{D unsupervised}. The second term in the L_{D unsupervised} classifies the images generated by the G as K+1 (fake).

$${L}_{D u n sup e r v i s e d} = - {E}_{x , y \sim Pdata ( X u )} log ( 1 - {P}_{m odel} ( y = K + 1 \vert {X}_{u} ) ) - {E}_{x \sim G ( z )} {log}_{Pmodel} ( y = K + 1 ) \vert x ) \qquad ( 2 )$$

By minimizing L_{Dsupervised} and L_{Dunsupervised}, the classifiers were trained with gradient descent. D weights were stochastically updated by their gradient (Equation 3) at each training step via gradient descent of Equations (1) and (2)

$$∇ θ d 1 / m {\sum }_{i = 1}^{m} - log σ ( {x}^{( i )} ) {y}^{( i )} - log D ( {x}_{u}^{i} ) - log ( 1 - D ( G ( {z}^{( i )} ) ) ) \qquad ( 3 )$$

FIG. 1 depicts aspects of the ESGAN and data workflow including the generator (G) and discriminator (D) submodels utilized to assess flowering status.

For all m samples in a minibatch, σ(x)j=P_{model} (y=j|x) (SoftMax function) was applied at the output of D supervised. After some preliminary experimentation, a 72-pixel image size was used as inputs for CNN and ESGAN given the negligent penalization in predictive performance but significant saving on computational time

Balanced sampling between annotated and unannotated images at each minibatch iteration was used to result in consistent performance of ESGAN during training. G was initialized with a latent vector (FIG. 7 pane A, orange vector) as input, which was then reshaped (FIG. 7 pane A, green cuboid) and upscaled through 2 deconvolution (i.e. transpose convolution) operations (FIG. 7 pane A, blue cuboids) into a fake image (FIG. 7 pane A, yellow cuboid) that matched the size of real images (FIG. 7 pane A, yellow cuboid) as the output of G. D inputs both real and fake 72×72×3 (FIG. 7 pane B, orange cuboid) images. It is then followed by 4 convolutional operations and max pooling layers of size 2, followed by a flattening layer and 40% features drop out. The size of the convolutional kernel was 3×3 and the Leaky ReLU activation function was applied to all the layers of G and D, except for the output of G, which used the Tanh function. The Adam optimizer and learning rate equal to 0.0001 were employed in G and D submodels. The size of the convolutional kernel was 3×3. Each classifier could predict the input data to a label y from 2 K classes (plants with or without panicles) or to a fake sample (k+1 class)

KNN and RF were implemented using Scikit-learn library, while CNN, ResNet-50, and ESGAN were implemented in Keras, both in Python version 3.9.16. Each model fitting was iterated 3 times using a random training and testing partition to ease the convergence of the models' prediction metrics. The number of image chips with the corresponding ground truth data was 3,921; 2,021 images came from the M. Sacchariflorus trial and 1,900 came from the M. sinensis trials. The full data set was split (80:20) into training and testing data sets. The training data set was split further (80:20) into training and validation data sets. The validation data set was used to improve the models' performance and prevent overfitting during training. CNN and ResNet-50 were trained for up to 300 epochs, while ESGAN was trained for up to 1,000 epochs. Early stopping strategies were incorporated in these 3 models to prevent overfitting, improve performance, and reduce computational time. The test data set was utilized to expose the models to unseen data to evaluate the generalization ability of the models. As the number of annotated images used for training was altered to generate the 8 sample size cases (FIG. 2, panes A and B), the number of test images was held constant at the equivalent of 20% of the full data set. This allowed all models to be evaluated on the same test set and size. Training was implemented on batches. Description of the batch training loop of ESGAN is as follows:
1) train D with frozen G weights:
   a) train supervised classifier with annotated images, and determine L_{D supervised}, gradient computation, and D weights update.
   b) train unsupervised classifier with real images, and determine L_{D unsupervised}, gradient computation, and D weights update.
   c) train unsupervised classifier with fake images, and determine L_{D unsupervised}, gradient computation, and D weights update.
2) train G with frozen D weights:
   a) feed D with G fake images.
   b) extract features and calculate G loss.
   c) update G weights by their gradient.

The OA, F1 score, and ROC curve analysis were utilized as performance metrics of the models with respect to classifying heading status (i.e. with or without visible panicles). OA and F1 score metrics are described in Equations (4) and (5):

$$O A = \frac{T P + T N}{T P + F N + F P + T N} , \qquad ( 4 )$$

$$F 1 score = \frac{T P}{T P + \frac{1}{2} ( F P + F N )} . \qquad ( 5 )$$

In Equations (4) and (5), true positive (TP) was defined as plants with panicles correctly classified as plants with panicles. True negative (TN) was defined as plants without panicles correctly classified as plants without panicles. False positive (FP) was defined as plants without panicles (i.e. ground truth) incorrectly classified as plants with panicles (i.e. positive class). False negative (FN) was defined as plants with panicles (i.e. ground truth) incorrectly classified as plants without panicles (i.e. negative class)

FIG. 7 includes a diagram of the ESGAN architecture. Components include: G (pane A) and D (pane B) submodels with the corresponding inputs (left vector and cuboid), hidden layers (center cuboids and vectors), and outputs (i.e. right cuboid as fake image in G and classes predictions in D).

ROC analysis is useful for assessing models where the output is a probability score that can be thresholded to produce binary decisions. The technique involves plotting the ROC curve, which is a graphical representation of a classifier's diagnostic ability between TP rate and FP rate at various threshold settings. The area under the ROC curve quantifies the overall ability of the classifier to discriminate between positive and negative classes.

Grad-CAM is a technique used in deep learning to visualize which parts of an image contribute the most to a model's decision. It highlights the regions of an input image that were more important for making a specific prediction. The technique was implemented to interpret the ESGAN D supervised classifier's learning process. The visualizing technique highlights the importance of different regions of the image in the output prediction by projecting back the weights of the output layer onto the convolutional feature maps. The following steps were used to generate the class activation maps. First, the ESGAN D supervised classifier mapped the input image to the activations of the last convolution layer as well as the output predictions. The gradient of the predicted value for the input image with respect to the activations of the last convolution layer was computed. Each image channel in the feature map array was weighed by how important this channel was with respect to the predicted value, and then all the channels were summed to generate the corresponding activation map array. The Grad-CAM activation map provided a measure of how strongly portions of the image contributed to the predictions made by the ESGAN D supervised classifier visualized in a 0 to 255 scale map array.

### III. Example Methods

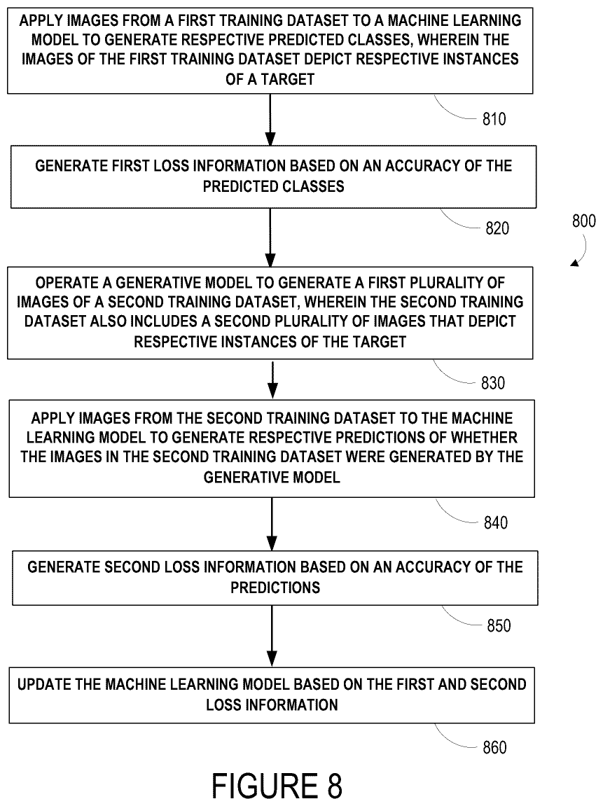

FIG. 8 is a flowchart of an example computer-implemented method 800. The method 800 includes applying images from a first training dataset to a machine learning model to generate respective predicted classes, wherein the images of the first training dataset depict respective instances of a target (810). The method 800 additionally includes generating first loss information based on an accuracy of the predicted classes (820). The method 800 additionally includes operating a generative model to generate a first plurality of images of a second training dataset, wherein the second training dataset also includes a second plurality of images that depict respective instances of the target (830). The method 800 additionally includes applying images from the second training dataset to the machine learning model to generate respective predictions of whether the images in the second training dataset were generated by the generative model (840). The method 800 additionally includes generating second loss information based on an accuracy of the predictions (850). The method 800 additionally includes updating the machine learning model based on the first and second loss information (860). The method 800 could include additional or alternative features.

### IV. CONCLUSION

It should be understood that arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

We claim:

1. A computer-implemented method comprising:
applying images from a first training dataset to a machine learning model to generate respective predicted classes, wherein the images of the first training dataset depict respective instances of a target;
generating first loss information based on an accuracy of the predicted classes;
operating a generative model to generate a first plurality of images of a second training dataset, wherein the second training dataset also includes a second plurality of images that depict respective instances of the target;
applying images from the second training dataset to the machine learning model to generate respective predictions of whether the images in the second training dataset were generated by the generative model;
generating second loss information based on an accuracy of the predictions; and
updating the machine learning model based on the first and second loss information.

2. The method of claim 1, wherein the machine learning model comprises convolutional neural networks.

3. The method of claim 1, further comprising updating the generative model based on the second loss information.

4. The method of claim 1, further comprising:
operating the generative model to generate a third plurality of images of a third training dataset, wherein the third training dataset also includes a fourth plurality of images that depict respective instances of the target;
applying images from the third training dataset to the machine learning model to generate respective predictions of whether the images in the third training dataset were generated by the generative model;
generating third loss information based on an accuracy of the predictions of whether the images in the third training dataset were generated by the generative model; and
updating the generative model based on the third loss information.

5. The method of claim 4, wherein the third plurality of images makes up between 40% and 60% of the third training dataset.

6. The method of claim 1, wherein at least one image of an instance of the target is present in both the first training dataset and the second plurality of images.

7. The method of claim 1, wherein the first training dataset includes images of instances of the target taken across a variety of lighting and environmental conditions.

8. The method of claim 1, wherein the target is a plant, wherein the predicted classes comprise first and second classes, wherein the first class represents whether an instance of the target depicted in an image has flowered, and wherein the second class represents whether an instance of the target depicted in an image has not flowered.

9. The method of claim 1, wherein applying images from the first training dataset to the machine learning model to generate respective predicted classes comprises applying an output of a terminal layer of the machine learning model to a softmax function.

10. The method of claim 1, wherein the machine learning model comprises a first output head and a second output head, wherein applying images from the first training dataset to the machine learning model to generate respective predicted classes comprises determining the predicted classes based on at least one output of the first output head, and wherein applying images from the second training dataset to the machine learning model to generate respective predictions of whether the images in the second training dataset were generated by the generative model comprises predicting whether the images in the second training dataset were generated by the generative model based on at least one output of the second output head.

11. The method claim 1, wherein the first training dataset and second plurality of images include a number of images that are labeled with ground truth labels for the predicted classes, wherein generating the first loss information based on an accuracy of the predicted classes comprises comparing predicted classes for images of the first training dataset with the ground truth labels for the images of the first training dataset, and wherein the number of images that are labeled with ground truth labels comprise less than 10% of the images of the first training dataset and second plurality of images.

12. The method of claim 1, wherein the first training dataset and second plurality of images include a number of images that are labeled with ground truth labels for the predicted classes, wherein generating the first loss information based on an accuracy of the predicted classes comprises comparing predicted classes for images of the first training dataset with the ground truth labels for the images of the first training dataset, and wherein the number of images that are labeled with ground truth labels comprise less than 1% of the images of the first training dataset and second plurality of images.

13. A non-transitory computer readable medium having stored therein instructions executable by a computing device to cause the computing device to perform operations comprising:
applying images from a first training dataset to a machine learning model to generate respective predicted classes, wherein the images of the first training dataset depict respective instances of a target;
generating first loss information based on an accuracy of the predicted classes;
operating a generative model to generate a first plurality of images of a second training dataset, wherein the second training dataset also includes a second plurality of images that depict respective instances of the target;
applying images from the second training dataset to the machine learning model to generate respective predictions of whether the images in the second training dataset were generated by the generative model;
generating second loss information based on an accuracy of the predictions; and
updating the machine learning model based on the first and second loss information.

14. The non-transitory computer readable medium of claim 13, wherein the operations further comprise updating the generative model based on the second loss information.

15. The non-transitory computer readable medium of claim 13, wherein the operations further comprise:
operating the generative model to generate a third plurality of images of a third training dataset, wherein the third training dataset also includes a fourth plurality of images that depict respective instances of the target;
applying images from the third training dataset to the machine learning model to generate respective predictions of whether the images in the third training dataset were generated by the generative model;
generating third loss information based on an accuracy of the predictions of whether the images in the third training dataset were generated by the generative model; and
updating the generative model based on the third loss information.

16. The non-transitory computer readable medium of claim 13, wherein the first training dataset includes images of instances of the target taken across a variety of lighting and environmental conditions.

17. The non-transitory computer readable medium of claim 13, wherein the target is a plant, wherein the predicted classes comprise first and second classes, wherein the first class represents whether an instance of the target depicted in an image has flowered, and wherein the second class represents whether an instance of the target depicted in an image has not flowered.

18. The non-transitory computer readable medium of claim 13, wherein applying images from the first training dataset to the machine learning model to generate respective predicted classes comprises applying an output of a terminal layer of the machine learning model to a softmax function.

19. The non-transitory computer readable medium of claim 13, wherein the machine learning model comprises a first output head and a second output head, wherein applying images from the first training dataset to the machine learning model to generate respective predicted classes comprises determining the predicted classes based on at least one output of the first output head, and wherein applying images from the second training dataset to the machine learning model to generate respective predictions of whether the images in the second training dataset were generated by the generative model comprises predicting whether the images in the second training dataset were generated by the generative model based on at least one output of the second output head.

20. The non-transitory computer readable medium of claim 13, wherein the first training dataset and second plurality of images include a number of images that are labeled with ground truth labels for the predicted classes, wherein generating the first loss information based on an accuracy of the predicted classes comprises comparing predicted classes for images of the first training dataset with the ground truth labels for the images of the first training dataset, and wherein the number of images that are labeled with ground truth labels comprise less than 1% of the images of the first training dataset and second plurality of images.
